(19) United States
(12) Patent Application Publication
(10) Pub. No.: US 2003/0028468 A1
(43) Pub. Date: Feb. 6, 2003

(54) Customized derivative securities

(75) Inventors: Patrick Man Ning Wong, Hong Kong (CN); James Yip, Hong Kong (CN); Siu Leung Li, Hong Kong (CN)

Correspondence Address: BAKER & BOTTS, 30 ROCKEFELLER PLAZA, NEW YORK, NY, 10112

(73) Assignee: iMarkets Technologies Limited

(21) Appl. No.: 09/849,013

(22) Filed: May 4, 2001

(51) Int. Cl. G06F 17/60

(52) U.S. Cl. 705/37; 705/36

(57) ABSTRACT

An issuer provides customized derivative securities to an investor by receiving from the investor data regarding the investor's desired risk-return values and at least one issuer of a traded security upon which the investment is to be partially based. A customized security having the desired risk-return value is formulated, and comprises at least one component related to the traded security of an issuer and at least one other component. The customized security is priced according to current market prices for the components and offered to the investor. In a preferred arrangement the method further includes trading the components of the customized security in amount corresponding to their inclusion in the customized derivative security accepted by the investor.

### BACKGROUND OF THE INVENTION

In connection with the provision of derivative security investments to the investing public, under current practice securities companies devise derivative securities and offer them to the public. Such securities are offered at websites, which include StructuredMarkets.com, CreditTrade.com and AsiaBondPortal.com. The issuers broadcast into cyber space a description of the product the being offered. An investor may accept or reject the product at its offered price and may also bid for the product at a better price than that which is offered. The buyer and seller negotiate the price through the continuous broadcasting of improved bid and ask price until a match is reached and a trade is transacted. In this transaction there is no way in which an investor can convey to the sellers the precise structure, and nature risk-return value of the investment that he wishes to make. Accordingly sellers are unable to provide customized products with the best pricing, and only offer products which are previously structured before being offered to the public.

The prior art also includes a variety of methods for adjusting portfolios of investments and monitoring investment portfolios for purposes of determining the risk-return evaluation of the portfolio. In some instances investor risk-return preferences are met by allocating an investment portfolio among a well defined list of investor products.

It is an object of the present invention to provide a method for providing a customized derivative security. The security may be customized according to the issuer or group of issuers on which the investment is to be based, and can be further structured by a mixture of investment or credit components to provide a customized security product which has a risk-return value desired by the investor.

### SUMMARY OF THE INVENTION

In accordance with the invention there is provided a method for providing customized derivative securities. An investor provides data regarding a desired risk-return value for an investment and selects a field and type of investment. A customized security is structured comprising a derivative security having at least one component related to the selected field of investment and at least one other component. The security is customized to have the customer desired risk-return value. The customized security is priced according to current market prices for the components and is thereafter offered to the customer.

In one preferred embodiment of the invention, selecting a field of investment may include selecting the security of an issuer. The security may be a long share component, a short share component, a long put option, a short put option, a long call option and a short call option. At least one other component may comprise a loan or a bond. According to a further embodiment of the invention the method is arranged to receive an acceptance of the customized security offered to the investor and to trade the components of the customized security in amounts corresponding to their inclusion in the customized derivative security. Preferably, the structuring includes selecting an amount of each component security in the product to achieve the risk-return value desired by the investor. The risk-return value of the customized security is derived from the risk-return values of the components of the security. In one arrangement the risk values are computed on the basis of the volatility of the component securities during a selected time period, such as a one year period. The expected return values of the security may be evaluated on the basis of the return value of the security over a selected period, such as one year. The risk values and the return values of the security are preferably normalized with respect to risk values and return values calculated for a standard, such as a stock exchange index value.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a drawing indicating various building blocks useful in connection with the customization of a derivative security and showing the combination of the building blocks in various arrangements to achieve derivative security customization.

FIG. 2 is a diagram illustrating steps in connection with the practice of a preferred embodiment of the method according to the present invention.

### DESCRIPTION OF THE INVENTION

Derivative products are usually based on a predetermined structure, which may be formulated by professionals, for example at an investment bank. The professionals will define the structure of the investment, such as a combination of a bond as a straight interest bearing investment and an option on a particular stock or other issue which is publicly traded. Once defined the investment bank usually arranges cover by purchasing a certain amount of the underlying components of the derivative security and thereafter offers the derivative security, as defined in advance, to the investing public. For example, by combining a bond with a call option on a stock, a derivative “synthetic convertible bond” investment can be created.

Investors may be interested in obtaining a derivative security, such as an equity linked note or a synthetic convertible, which is based on an underlying issue, such as stock in a particular issuer. Following conventional practice this security may not have been pre-formulated by an investment bank, and hence may be unavoidable. Further, investors may have different risk and return criteria for their investment, which would call for a different mix, for example, of the bond and option components of a derivative security. The present invention is based on the concept that a derivative security can be customized to the investment desires and risk-return criteria of an individual investor. This customization is achieved by structuring a customized security to have two or more components, at least one of which is based on traded securities of an issuer or group of issuers. The amount of each component in the customized security is selected according to the risk-return desires of the individual investor. Once the customized security has been formulated it is priced according to current market conditions and offered to the investor. If the investor accepts a quantity of the customized security, the commercial bank or investment bank that has structured the security can cover its position by buying or selling the components of the security in amounts corresponding to their inclusion in the customized derivative.

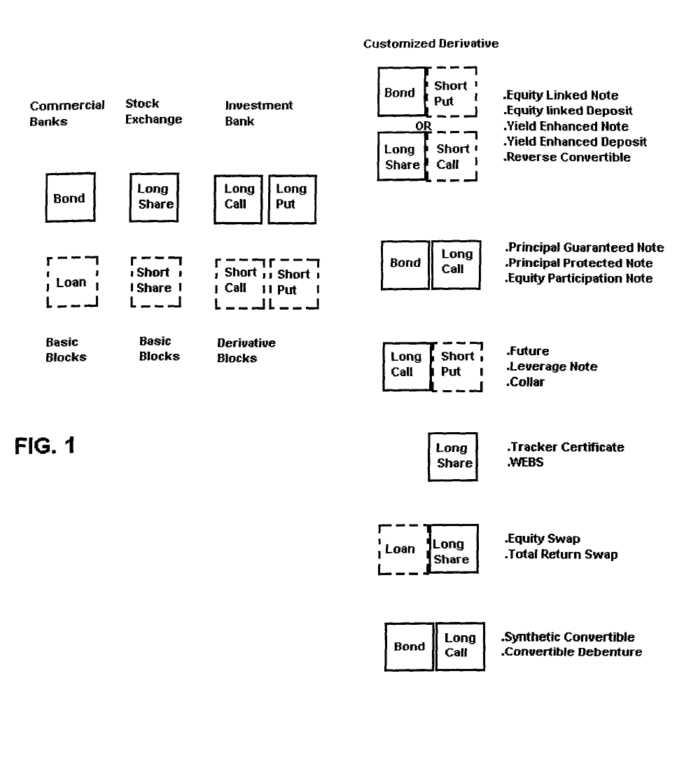

Referring to FIG. 1 there are shown various building blocks of a customized security. Commercial banks make available loans or bonds paying a fixed interest rate and having a fixed term. The stock exchanges make available for purchase or sale securities including stock of various issuers, such as corporations. The building blocks available on a stock exchange consist of either a long or a short position in shares of a selected issuer. Additional building blocks are options based on a traded security of an issuer, such as call options and put options, each having a defined maturity and each having a set price. An investor can take a long or a short position with respect to a call or put option. For example, if an investor takes a long position with respect to a call option, the investor pays a premium for the right to purchase the underlying security of the issuer at a specified price within a specified period of time. If a customer or investor buys a put option on a security the investor buys the right to sell the security at a specified price within a specified period of time for a specified premium. On the other hand an investor may take a short position with respect to either a call or a put option. The call option grants whoever buys the option the rights with respect to the long position and the person entering into a short position on such options receives the premium on the option at the time it is sold. It is well-known that by combining positions in a security the risk-return values of the security to the investor can be altered. In addition, different securities may be combined to achieve various investor strategies. A common derivative investment scheme calls for, for example, the purchase of a fixed rate bond and the concurrent purchase of a long position with respect to a call option on a specified security of an issuer. The result of this combination is sometimes called an equity participation note. In this derivative investment the investor obtains the benefit of the fixed interest rate associated with the bond, less the premium paid on the call option, but has a greater return on the investment if the underlying security of the call option rises in value at which point the investor realizes additional profit on the call option. Options, by their nature, are highly leveraged investments and consequently have a high volatility. In the appropriate market, however, options can provide a high rate of return to the investor. Bonds on the other hand have a fixed and relatively low expected rate of return and have a very low volatility, since the investment principle is most usually realized at maturity as are the dividends. Accordingly, bonds have an historically low risk and low return. In an investment such as a combination of a bond and a long position on a call option the investor can adjust the risk-return of the investment by adjusting the ratio of his investment in the bond and in the call option. If the investment is 100% bond, the risk and return is the lowest. If the investment is 100% call, the volatility risk and possible return are the greatest. Accordingly, by adjusting the content of a derivative security the entire range of risk-return value can be realized to the individual investor.

The present invention provides a method for formulating a customized derivative security having at least two components, one of which is related to the security of an issuer selected by the investor. The components are combined in a ratio which achieves the desired risk-return value sought by the individual investor. For example, in the case of an equity participation note comprising a combination of a bond investment and a call option, a higher percentage of call option would yield a higher risk-return value whereas a higher percentage of bond investment yields a lower risk-return value. As shown in FIG. 1 the various building blocks of the investments can be used as component investments for a wide variety of investment products. For example, in the event an investor wishes to invest in a particular industry for which there is no defined investment product, for example, the widget industry, it is possible for the derivative to be structured by the commercial or investment bank to have a combination of shares in various companies in the widget industry, and the ratio of those shares can be adjusted according to the historical risk-return data for the particular components of issuers within that industry to achieve the risk-return value which is most desired by the individual investor.

Another example is allocating the percentage of margin purchase of a particular security by determining the risk value associated with the margin investment by use of historical data related to the underlying security.

In most instances of derivative security generation by an investment bank or commercial bank, the derivative security is selected to be one which will be generally desirable to the investing public. According to the present invention, the derivative security can be highly customized and the customization may be done in a way which does not present a risk to the issuer of the derivative security.

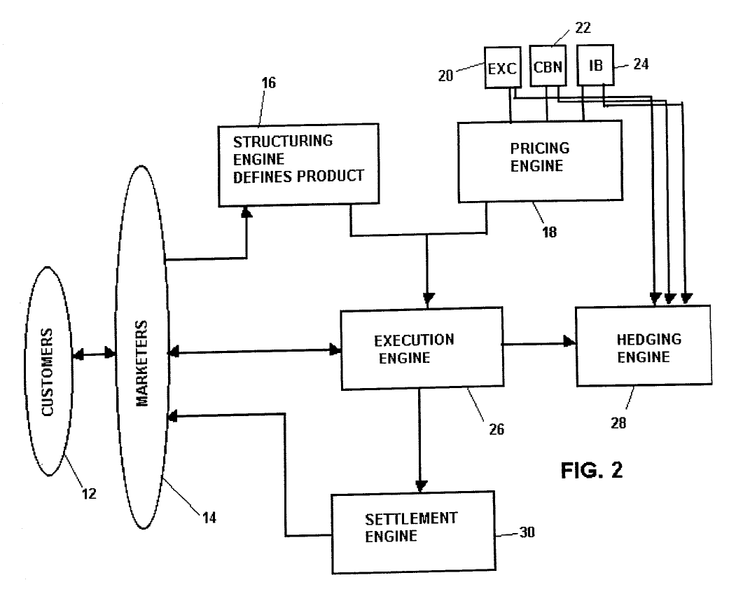

Referring to FIG. 2 there is shown a series of steps in connection with executing a trade in a customized derivative security following a preferred embodiment of the present invention. Customers 12 communicate to their investment bank, commercial bank, private bank or stock broker, acting as a marketer 14, the particulars of their desired investment. For example, an investor may wish to obtain an equity linked note linked to an issue of stock, which is not the subject of a currently available packaged derivative product. The investor can also select the desired risk-return value for the investment. The data provided by the customer is provided to a structuring engine 16 which may be operated by an investment bank or commercial bank which is acting as issuer of the customized derivative security. On the basis of the investment criteria defined by the customer, structuring engine 16 defines a customized security product and a combination of components in a selected ratio which may include at least one component related to a traded security of an issuer specified by the customer and at least one other component. The ratio of the components in the customized derivative investment product is determined to match the risk-return desires set by the investor. The structuring engine refers to a data base which provides historical values of the prices of components being used in connection with the customized security, for example, the volatility of the security over a past year and a rate of return of a security over the past year. In a preferred arrangement these risk-return values are normalized to risk-return values in a standardized index, such as a stock exchange index. Once a product has been defined according to the risk-return desires of the investor the product definition is provided to a pricing engine 18 which obtains pricing information from a stock exchange database 20 bond or a loan information from a commercial bank 22 and possibly option pricing information from an investment bank 24. The pricing engine then determines from the price of the various components of the customized derivative security the price at which the customized derivative security should be offered to the customers 12. The customized derivative security and its pricing information is communicated to the customers through the marketing organization by execution engine 26. In the event the customer decides that they desire to obtain or make an investment in the customized derivative security the investment acceptance is communicated to execution engine 26. Execution engine 26 then provides appropriate information to hedging engine 28 which undertakes to purchase specified amounts of the components of the customized derivative security on the stock exchange 20, from commercial bank 22, and from investment bank 24, in order to hedge the position of the security issuer with respect to the customized security. Once the hedging has been completed the transaction is provided to settlement engine 30 which provides settlement between the issuer and the marketing organizations 14 as well as settlement between the issuer and the providers of the components consisting of exchange 20, commercial bank 22 and investment bank 24.

set of benchmark measures is provided for assessing risk and return of an investment product/portfolio and for providing “apples-to-apples” comparison amongst different investment portfolios and across asset classes.

Risks of individual investments are mapped, relative to a benchmark, onto a common scale that is called RiskIndex. For investment products in Hong Kong, the benchmark is the Hang Seng Index. The RiskIndex for Hang Seng Index is arbitrarily chosen to have a value of 10 and this corresponds to the historical annualized volatility (σ) of Hang Seng Index over the last 12 months, measured as 30.6%. The RiskIndex of an investment product is defined as

$$RiskIndex = σ1 \frac{10}{σ HSI}$$

Thus we can say that a stock with a RiskIndex of 40 is twice as risky as another investment product with a RiskIndex of 20.

Expected returns of individual investments are mapped, relative to a benchmark, onto a common scale that is called ReturnIndex. For investment products in Hong Kong, the benchmark is the Hang Seng Index. The ReturnIndex for Hang Seng Index is arbitrarily chosen to have a value of 10 and this corresponds to the historical returns (r) of Hang Seng Index over the last 12 months, measured as 11.6%. The ReturnIndex of an investment product is defined as

$$RiskIndex = ri \frac{10}{rHSI}$$

Thus we can say that a stock with a ReturnIndex of 16 generates twice as much return as an investment product with a ReturnIndex of 8.

For a stock issue, expected return, E(rₛ), is estimated by the historical returns of the stock over the last 12 months (i.e. E(rₛ)=rₛ)

Risk, better known as volatility, σₛ, is measured by the standard deviation of historical logarithmic returns over the last 12 months.

For a leveraged stock investment expected return is computed as follows:

Let Qs=total funds invested in stock

Q_{B}=total borrowings

rs=expected return of stock

r_{F}=borrowing rate (assumed to be the risk-free rate)

E(r_{L})=λrₛ+(1−λ)r_{F}

where

$$λ = \frac{Qs}{Qs - QB} = \frac{total funds invested}{total funds invested - borrowing}$$

Volatility for a leveraged (margin) stock investment is:

σ_{L}=λσₛ

For a call option volatility is computed as:

$${σ}_{c} = {Ωσ}_{s}$$

$$where$$

$$Ω = \frac{S}{C} * unit delta of call$$

where S is the stock price and C is the call option price.

Expected return for a call option is

r_{c}=Ω(r^{s}−r_{F})+r_{F}

For a put option volatility is computed as:

$${σ}_{p} = - {Ωσ}_{s}$$

$$where$$

$$Ω = \frac{S}{C} * unit delta of put$$

where S is the stock price and P is the put option price.

Expected return is

rₚ=Ω(rₛ−r_{F})+r_{F}

For an equity-linked product (ELD)

Expected return is

ELD≡Ke^{-rt}−P

% of dollar amount invested in deposit

$${W}_{D} = \frac{{Ke}^{- rt}}{{Ke}^{- rt} - P}$$

% of dollar amount invested in put

$${W}_{p} = \frac{- P}{{Ke}^{- rt} - P}$$

$$E ( {r}_{ELD} ) = {w}_{D} E ( {r}_{D} ) + {w}_{p} E ( {r}_{p} )$$

where K is the strike price of the put, P is the option price and rt is riskless interest rate multiplied by the time to maturity of the put option.

Volatility is:

$$σ ELD = \sqrt{{w}_{p}^{2} {σ}_{p}^{2}}$$

For principal guaranteed products (PGD) expected return is:

PGD≡Ke^{-rt}+C

% of dollar amount invested in deposit

$${W}_{D} = \frac{{Ke}^{- rt}}{{Ke}^{- rt} + C}$$

% of dollar amount invested in call

$${W}_{c} = \frac{C}{{Ke}^{- rt} + C}$$

$$E ( {r}_{PGN} ) = {w}_{D} E ( {r}_{D} ) + {w}_{c} E ( {r}_{c} )$$

where K is the strike price of the call option, C is the call option price and rt is riskless interest rate multiplied by the time to maturity of the call option.

Volatility is:

$${σ}_{P G N} = \sqrt{{w}_{c}^{2} {σ}_{c}^{2}}$$

Numerical examples are given as follows:

| | | | Expected | | |
|---|---|---|---|---|---|
| Investment | Product/Strategy | Volatility | Return | Risk Index | Return Index |
| A | Riskless Interest rate | 0.00% | 6.00% | 0.00 | 5.19 |
| B | Buy HSBC | 31.34% | 15.05% | 10.24 | 13.02 |
| C | Buy HSBC on 50% margin | 62.68% | 24.20% | 20.48 | 20.85 |
| D | Buy 3-M ATM call on HSBC | 265.18% | 82.58% | 86.66 | 71.43 |
| E | Buy 3-M 10% OTM call on | 344.59% | 105.51% | 112.61 | 91.27 |
| | HSBC | | | | |
| F | Buy 3-M ATM put on HSBC | 255.04% | −67.65% | 83.35 | −58.52 |
| G | Buy 3-M 10% OTM put on | 347.72% | −94.41% | 113.64 | −81.67 |
| | HSBC | | | | |
| H | Buy 3-M 10% OTM ELD on | 7.00% | 9.02% | 2.29 | 6.94 |
| | HSBC | | | | |
| I | Buy 3-M ATM 100% PGD on | 16.83% | 19.86% | 5.50 | 9.39 |
| | HSBC | | | | |

| | | | | |
|---|---|---|---|---|
| Benchmark His | 30.60% | 11.56% | 10.00 | 10.00 |

While there has been described what is believed to be the preferred embodiment of the present invention, those skilled in the art will recognize and other and further changes and modifications may be made thereto without departing from the spirit of the invention, and it is intended to claim all such changes and modifications as fall within the true scope of the invention.

We claim:

1. A method for providing customized derivative securities, comprising:
receiving from an investor data regarding a desired risk-return values and selection of at least one issuer of traded securities;
structuring a customized security having at least one of said desired risk-return value and comprising a derivative security having at least one component related to said traded securities of said issuer and at least one other component;
pricing said customized security according to current market prices for said components; and
offering said customized security to said investor.

2. A method as specified in claim 1 wherein said component related to traded securities comprises a component selected from the group comprising a long share component, a short share component, a long put option, a short put option, a long call option and a short call option.

3. A method as specified in claim 2 wherein said at least other component comprises a loan or a bond

4. A method as specified in claim 1 further comprising receiving an acceptance for said customized security from said investor and covering the position by trading said components in amounts corresponding to their inclusion in said customized derivative security.

5. A method as specified in claim 1 wherein said structuring includes selecting relative amounts of said components of said customized securities to achieve one of said risk-return values specified by said investor.

6. A method as specified in claim 5 wherein said risk return values are normalized to selected standard risk-return values.
